(19) United States
(12) Patent Application Publication
(10) Pub. No.: US 2016/0116055 A1
(43) Pub. Date: Apr. 28, 2016

(54) PLANETARY GEAR DEVICE

(71) Applicant: BAE SYSTEMS HÄGGLUNDS AKTIEBOLAG, Örnsköldsvik (SE)

(72) Inventor: Daniel ENGBLOM, Bonässund (SE)

(73) Assignee: BAE Systems Hägglunds Aktiebolag, Örnsköldsvik (SE)

(21) Appl. No.: 14/894,282

(22) PCT Filed: May 27, 2014
(86) PCT No.: PCT/SE2014/050645

§ 371 Date: Nov. 25, 2015

(30) Foreign Application Priority Data
May 30, 2013 (SE) 1350659-7

(51) Int. Cl. F16H 57/08

(52) U.S. Cl. CPC F16H 57/082

(57) ABSTRACT

The present invention relates to a device at planet wheel(s) where a planet wheel is rotatably journaled at a pin arranged to be supported by means of a planet carrier for supporting said planet wheel. Said pin is non-rotatably arranged in said planet carrier by means of opposed blocking means arranged to cooperate by means of a blocking portion of said planet carrier, wherein said blocking means comprises projecting portions projecting from said planet carrier for cooperation with a locking configuration arranged to axially retain said pin in said planet carrier.

### CROSS REFERENCE TO RELATED APPLICATIONS

This application is a U.S. National Stage patent application of PCT/SE2014/050645, filed on May 27, 2014, which claims priority to Swedish Patent Application No. 1350659-7, filed on May 30, 2013, the entire contents of which are incorporated herein by reference.

### FIELD OF THE INVENTION

The invention relates to a device at planet wheel(s) according below.

### BACKGROUND OF THE INVENTION

There is a variety of methods for locking the so-called planet sticks at the planet carrier of a planet gear.

In an alternative, the planet stick can be locked by swaging/riveting the planet stick. A drawback of such a solution is that the planet stick cannot be disassembled.

In an alternative, the planet stick is locked by shrink fitting. A drawback of such a solution is that the planet sticks can tend to loosen. A further disadvantage of shrink fitting is that it, during production, is more complicated to obtain a specific rotation position of conduit of oil of oil channels in the planet sticks. Further, it is difficult to disassemble/reassemble without damages.

In a further alternative, the planet stick is locked by radial co-boring and locking peg, wherein the peg is hit manually. Hereby, it is prevented that the planet stick loosens and further the planet stick is correctly rotation oriented for oil channels. However, the manual handling results in that the solution will be costly.

Other alternatives of locking the planet stick at the planet carrier are locking by a locking ring about the planet stick which can lead to that the planet stick loosens, locking by axially co-bored/threaded locking screw which is costly both in fabrication and assembling, as well as locking by twisted metal sheet, which requires manual assembling, takes some place axially and there is a risk that a screw loosens, as well as requires environmentally harmful locking fluid or manual swaging after assembling, which in turn complicates the disassembling.

For a planet carrier, it is important to securely lock the planet stick substantially axially. For compact gears, it is important that the height of the locking mechanism is limited. The total cost of the locking is important. For planet sticks having internal lubrication also the rotation position of the planet stick is important. It is also important that the locking method is not adversely affected by centripetal forces as the planet gears often rotates at high speeds, especially when they are coupled to electric motors for driving the vehicle.

WO2011060362 discloses a planet carrier where a tongue, arranged as an integral part of the planet carrier, locks the rotation of the planet stick. Hereby, the planet stick is non-rotatably arranged in said planet carrier by means of opposed blocking means arranged to cooperate by means of a blocking portion of the planet carrier. A disadvantage of the integrated solution is that both of the passes of the planet carrier will be difficult to co-process for good precision. Further, this solution results in that the assembling of planet sticks with planet wheel(s) becomes complicated. Further, the solution requires that the planet stick having drive is clamped permanently in order to manage operation.

### SUMMARY OF THE INVENTION

An object of the present invention is to provide a device at planet wheel(s) allowing cost efficient, secure and removable locking of pin arranged for bearing of planet wheel and further facilitating rotation locking circumferentially of the pin.

These and other objects, which will become apparent from the following description, is provided by a device at the planet wheel(s) of the initially mentioned kind and which further exhibits the features indicated below. Preferred embodiments of the device are defined below.

According to the invention, the objects are obtained by a device at planet wheel(s) where a planet wheel is rotatably journaled at a pin arranged to be supported by means of a planet carrier for supporting said planet wheel, wherein said pin is non-rotatably arranged in said planet carrier by means of opposed blocking means arranged to cooperate by means of a blocking portion of said planet carrier, wherein said blocking means comprises projecting portions projecting from said planet carrier for cooperation with a locking configuration arranged to axially retain said pin in said planet carrier. This allows for cost efficient, secure and removable locking of the pin arranged for bearing of planet wheels. Further, rotation locking circumferentially of the pin is facilitated such that, for example, oil channels of the pin are oriented correctly for cooling/lubrication of the planet wheel. It also allows for easy assembling of the respective pin at the planet carrier.

In an embodiment of the device, said locking configuration comprises a locking ring arranged in a groove of said blocking means. Hereby, simple and effective locking is obtained.

In an embodiment of the device, said groove is arranged internally of said blocking means. Hence, during locking by means of a locking ring, resiliently acting in the groove, simple and effective locking is obtained wherein the risk of loosening the pin during rotation due to centripetal force hereby is eliminated.

In an embodiment of the device, said groove is arranged in said projecting portions of said blocking means. This enables simple and efficient axial locking of the pin by cooperation with said locking configuration, for example a locking ring, in said groove.

In an embodiment of the device, said locking configuration is arranged to resiliently act in said groove. This provides effective retention of the pin and hence effective axial locking of the pin.

In an embodiment of the device, said locking configuration is arranged to removably retain said pin in said planet carrier. Hereby, the pin can hence be disassembled from the planet carrier such that, in case of defect of the planet wheel and/or planet stick, not the whole planet carrier needs to be discarded, but only the defective part.

In an embodiment of the device, said blocking portion comprises opposed recesses for said blocking means together with an intermediate portion running between said recesses. This provides simple and effective locking circumferentially of the planet stick for facilitating of for example orientation of coolant/lubricant channels of the planet stick.

In an embodiment of the device, said planet carrier comprises a separate disk shaped ring member along which the blocking portions are distributed circumferentially about said ring member. This facilitates the assembling as it, in an alternative, does not require additional fastening members but can be retained by means of the locking configuration, here the locking ring, at the respective pin.

In an embodiment of the device, said planet carrier comprises separate fastening portions having blocking portions, which fastening portions are distributed circumferentially about said planet carrier. Such separate fastening portions are fastened by means of connections such as screw connections, wherein axial movement of the pin is prevented by the thus fastened separate fastening portion during assembling before the locking ring has been applied. Hence, herein no stop is required in the opposite end of the pin.

In an embodiment of the device, said pin has an overall cylindrical configuration and at one of its ends has an axial recess arranged, by means of a diametrically running recess, to form said opposed blocking means and wherein the groove of said blocking means is arranged in said axial recess. This enables simple and efficient rotation locking circumferentially. Such a design of the pin is also relatively simple to construct by processing, where the pin mainly is manufactured in lathe with milling head, wherein it is cured and grinded to correct tolerance.

### BRIEF DESCRIPTION OF THE DRAWINGS

This invention will be better understood by reference to the following detailed description read together with the accompanying drawings, wherein equal reference numerals refer to the same parts throughout the several views, and in which:

FIG. 1a schematically illustrates a plan view of a planet gear configuration comprising a device at the planet wheel in an embodiment of the present invention;

FIG. 1b schematically illustrates a side view planet gear configuration of FIG. 1a;

FIG. 1c schematically illustrates a cross-sectional view of the planet gear configuration in FIG. 1;

FIG. 2a schematically illustrates a perspective view of the planet gear configuration of FIG. 1a without ring wheel;

FIG. 2b schematically illustrates a side view of the planet gear configuration of FIG. 2a;

FIG. 2c schematically illustrates a plan view of the planet gear configuration of FIG. 2a;

FIG. 2d schematically illustrates a cross-sectional view of the planet gear configuration of FIG. 2a;

FIG. 3 schematically illustrates an exploded perspective view of the planet gear configuration of FIG. 2a;

FIGS. 4a and 4b schematically illustrate perspective views of a pin of the device of FIG. 1a for rotatable bearing of the planet wheel in an embodiment of the present invention;

FIG. 4c schematically illustrates a side view of the pin of FIGS. 4a and 4b;

FIG. 4d schematically illustrates a cross-sectional view of the pin of FIGS. 4a and 4b;

FIG. 5a schematically illustrates a perspective view of a planet gear configuration comprising a device at planet wheel(s) in an alternative embodiment of the present invention; and

FIG. 5b schematically illustrates a plan view of the planet gear configuration of FIG. 5a;

### DETAILED DESCRIPTION OF THE INVENTION

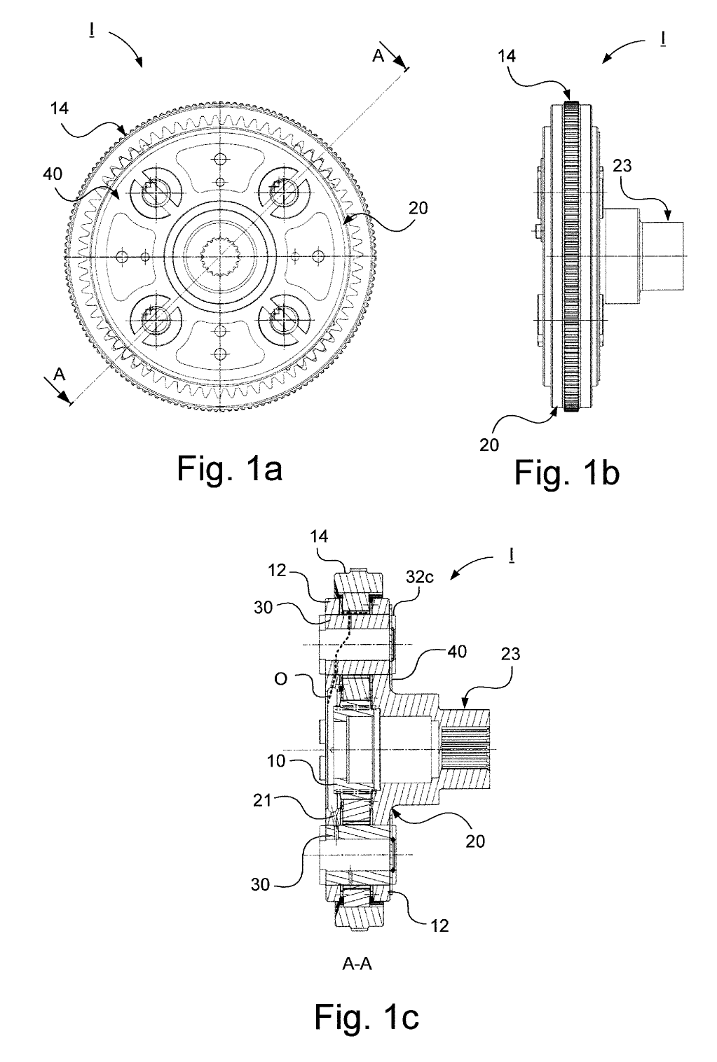

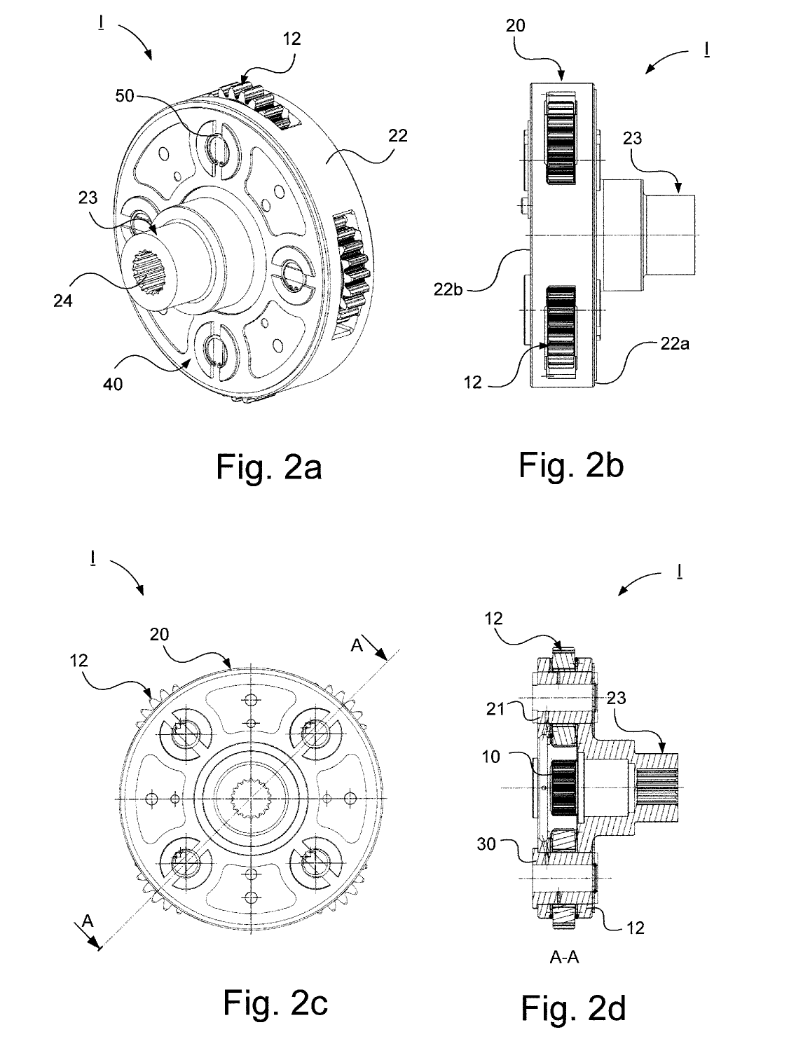

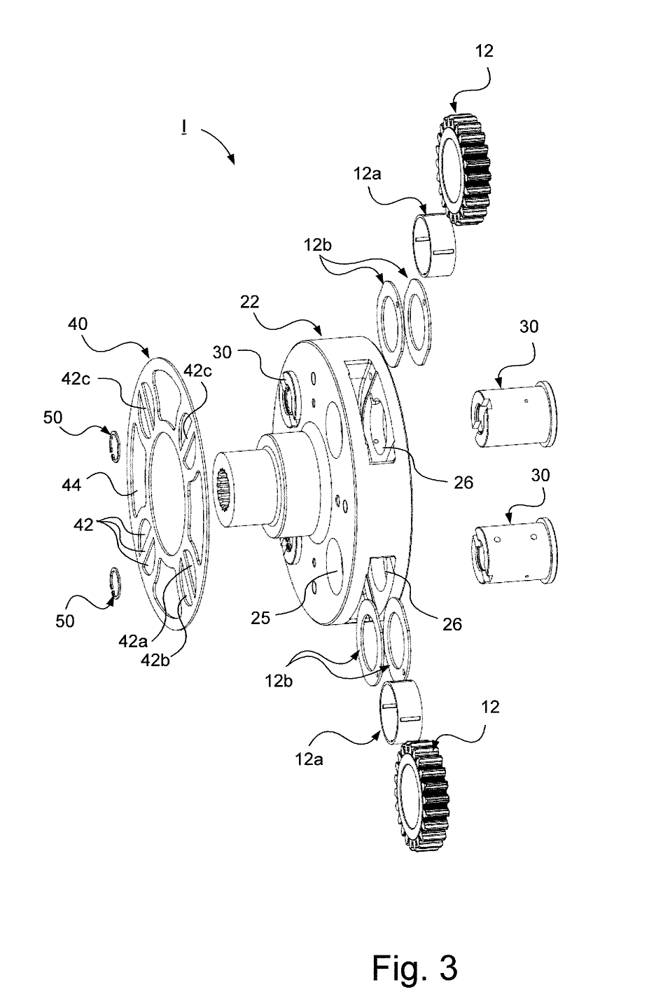

FIGS. 1a-c, FIGS. 2a-d and FIG. 3 schematically illustrate different views of a planet gear configuration I comprising a device at planet wheel(s) in an embodiment of the present invention.

The planet gear configuration I comprises a sun wheel 10, a set of planet wheels 12 carried by a planet carrier 20, and a ring wheel 14, where the ring wheel only is shown in FIGS. 1a-c. In the planet gear configuration I, the sun wheel 10 is engaged with the set of planet wheels 12, and the planet wheels 12 of the set of planet wheels 12 are engaged with the ring wheel 14. The planet carrier 20 of the planet gear configuration I is arranged to transfer the output torque to an output shaft, in an alternative for driving ground-engaging means such as wheels or tracks of a motor vehicle.

The respective planet wheel 12 is rotatably arranged at a pin 30 arranged to be supported by means of the planet carrier 20 for supporting said planet wheel 12.

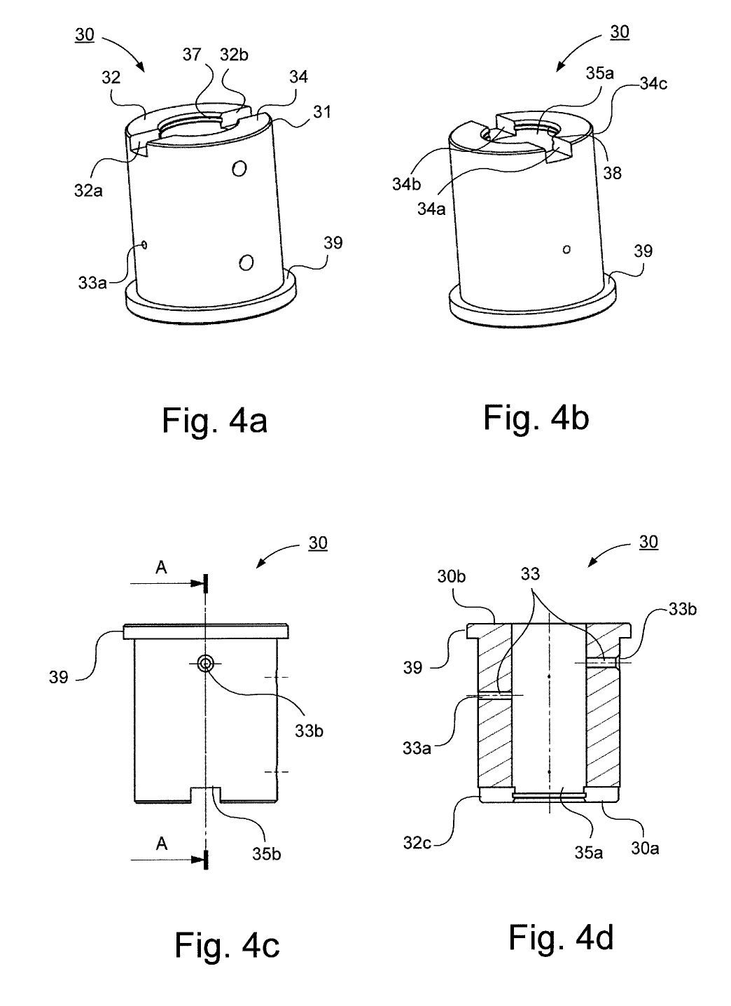

The pin 30 is non-rotatably arranged in said planet carrier 20 by means of opposed blocking means 32, 34 arranged to cooperate by means of a blocking portion 42 of said planet carrier, as shown in FIGS. 3 and 4a-d. Said blocking means 32, 34 comprise projecting portions projecting from said planet carrier for cooperation with a locking configuration 50 provided to axially retain said pin 30 in said planet carrier 20.

The planet carrier 20 comprises channels 21 for the supply of coolant/lubricant O for cooling and lubrication of the planet wheels.

In this embodiment, said planet carrier 20 comprises a separate disc-shaped ring member 40 along which blocking portions 42 are distributed circumferentially of said ring member 40. The planet carrier further comprises a substantially cylindrical hollow carrier body 22. The carrier body 22 has a first side 22a against which the disc-shaped ring member 40 is arranged to be applied as well as an opposite second side 22b, from which said pins 30 are intended to be inserted.

The planet carrier 20 has a shaft portion 23 projecting from the first side of the carrier body for connection to an output shaft.

In an alternative, the planet carrier 20 has a through bore 24 running axially through the shaft portion and the carrier body for weight reduction and facilitation of transportation of coolant/lubricant to stock.

The carrier body has an internal space. The carrier body has through openings 25 evenly distributed circumferentially along the carrier body axially running about the axial portion through the first and second sides for insertion of said pins. Hence, said axially running openings 25 are intended to be brought in line with respective blocking portions of the disc-shaped ring member 40.

Further, the carrier body 22 has side openings 26 evenly distributed along its envelope surface for insertion of planet wheels 12 and bearing rings 12a for the planet wheels, which may be constituted by needle bearings, alternatively slide, ball or roller bearings, as well as thrust bearings 12b, which may be constituted by thrust needle bearings, alternatively slide, ball or roller bearings, when assembling the planet gear configuration I.

The respective blocking portion 42 comprises opposed recesses 42a, 42b for said blocking means 32, 34 together with an intermediate portion 42c running between said recesses 42a, 42b. In this embodiment, said opposed recesses 42a, 42b are crescent-shaped, wherein the straight running sides of the respective crescent-shaped recess 42a, 42b face each other and run parallel and spaced from each other forming said intermediate portion 42c. In this embodiment, said intermediate portions 42c of the respective blocking portion 42 are arranged to run substantially perpendicular to the radial extension of said disc-shaped ring member 40.

In this embodiment, the disc-shaped ring member 40 comprises weight reducing recesses 44 distributed along the ring member 40 between the adjacent blocking portions 42.

FIGS. 4a-d schematically illustrate different views of the pin 30 of the device of FIG. 1a for rotatable bearing of the planet wheel 12 in an embodiment of the present invention.

Said pin 30 has an overall cylindrical configuration. Said pin 30 has at its one end 30a an axial recess 35a arranged to by means of a diametrically running recess 35b form said opposed blocking means 32, 34. This end 30a forms the first end 30a. Said pin 30 has a second end 30b opposite the first end 30a.

Said axial recess 35a is substantially circular cylindrically and coaxially arranged in the pin 30. Hence, said axial recess 35a has a diameter smaller than the diameter of the pin 30.

In this alternative, said axial recess 35a is running axially through said pin 30.

In a non-illustrated alternative, said axial recess is constituted by a blind hole arranged to run axially to at least the same depth as said diametrically running recess.

The respective blocking means 32, 34 is constituted by an arcuate portion axially projecting from said diametrically running recess having an outer side with an outer radius corresponding to the outer radius of the pin and an inner side with an inner radius corresponding to the radius of said axial recess. Hence, the blocking means is arcuate.

The respective arcuate blocking means 32, 34 further has an end surface, arranged substantially perpendicular to the axial direction, constituting the first end 30a of the pin 30.

The respective arcuate blocking means 32, 34 further has a chamfer 31 arranged at the transition between the end surface and the outer surface for facilitating insertion of the pin 30 in said opposed recesses 42a, 42b of the blocking portion 42. Hence, the overall cylindrical pin 30 has a chamfer 31 arranged at the first end 30a at the transition between the outer side of the pin 30 and the first end 30a.

The respective arcuate blocking means 32, 34 further has first and second end portions 32a, 32b, 34a, 34b having surfaces running in the axial direction. The end portions 32a, 32b, 34a, 34b of the first arcuate blocking means 32 face the end portions 34a, 34b of the second arcuate blocking means 34 so that said diametrically running recess 35b is formed.

The respective arcuate blocking means 32, 34 has said projecting portion, during insertion of the pin 30 in said opposed recesses 42a, 42b of the blocking portion 42 of the planet carrier 20, from the planet carrier 20 and hence from said blocking portion 42.

The respective blocking means 32, 34 comprises an internally arranged and circumferentially running groove 37, 38. Said groove is arranged in said projecting portions of said blocking means 32, 34.

The groove 37, 38 of the respective blocking means 32, 34 is arranged in said axial recess 35a. The groove 37, 38 of the respective arcuate blocking means 32, 34 is arranged to run internally of respective blocking means 32, 34 substantially parallel to and spaced from the end surface 30a of the blocking means 32, 34. The groove 37, 38 of the respective arcuate blocking means is arranged to run in said projecting portion of the respective arcuate portion.

Said locking configuration 50 comprises a locking ring 50 intended to be arranged in the internal groove 37, 38 of the respective blocking means 32, 34. Said locking ring 50 is arranged to resiliently act in said groove 37, 38. The locking configuration 50 in the form of the locking ring 50 is arranged to removably retain said pin 30 in said planet carrier 20, as shown in FIG. 1.

Said pin 30 has a stop portion 39 arranged at the second end 30b of the pin 30 in the form of a circumferentially running edge portion 39 with a larger diameter. Hence, said edge portion 39 projects radially from the outer side of the substantially circular cylindrical pin 30 at the second end 30b of the pin 30. The edge portion 39 is dimensioned so that the pin 30 is not allowed to be passed through said axially running openings during insertion of the pins so as to facilitate assembling.

Said pin 30 further comprises a channel configuration 33 for receiving and distributing coolant/lubricant O to the planet wheels 12 journaled to the respective pin 30.

Said channel configuration 33 comprises an inlet 33a arranged to be brought in line and in fluid communication with said channel 21 of the planet carrier 20 and an outlet 33b arranged adjacent to the planet wheel 12 journaled to the pin 30.

The channel configuration 33 of the respective pin 30 and the channels 21 of the planet carrier 20 fluidly communicating with the channel configuration 33 of the respective pin have a substantially radial extension so as to utilize the centrifugal force of the planet carrier for distribution of coolant/lubricant O to the planet wheels 12 journaled to the respective pin 30.

In an alternative, said coolant/lubricant is oil based.

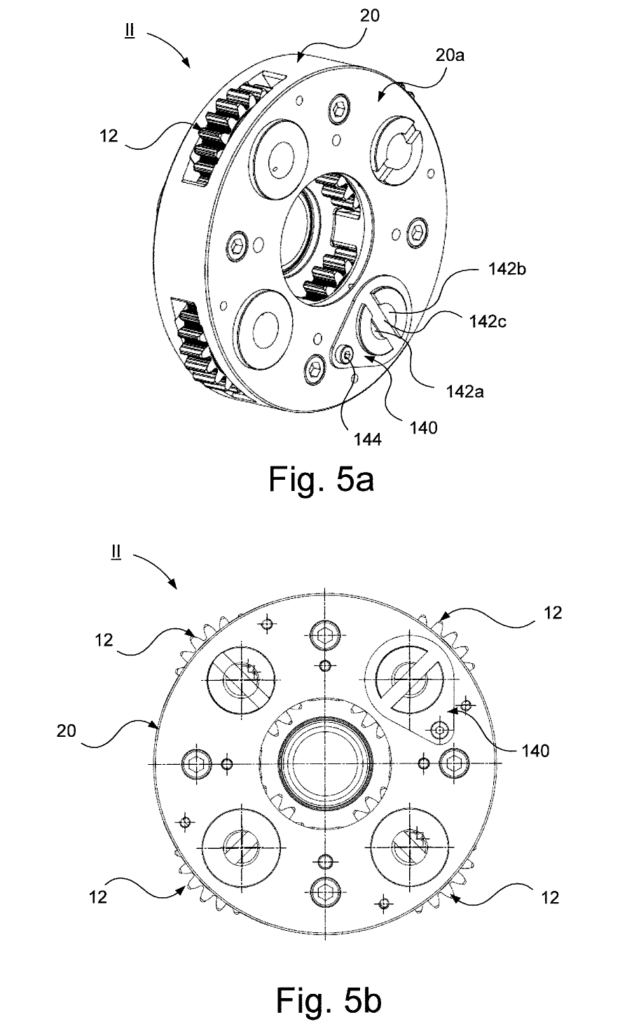

FIGS. 5a-b schematically illustrate different views of a planet gear configuration II comprising a device at planet wheel(s) in an alternative embodiment of the present invention.

The device at planet wheel(s) of the embodiment illustrated in FIGS. 5a-b substantially differs from the device at planet wheel(s) of the embodiment illustrated in FIGS. 1a-c, FIGS. 2a-d and FIG. 3 by how said fastening portions are arranged and formed.

In this embodiment, said planet carrier comprises separate fastening portions 140 having blocking portions which fastening portions 140 are distributed circumferentially of said planet carrier. FIGS. 5a-b show such a separate fastening portion 140.

The fastening portion 140 comprises a blocking portion 142 in accordance with the blocking portion 42 in the embodiments illustrated in FIGS. 1a-c, FIGS. 2a-d and FIG. 3, and hence comprises opposed recesses 142a, 142b of the blocking means together with an intermediate portion 142c running between said recesses. In this embodiment, said opposed recesses 142a, 142b are crescent-shaped, wherein the straight running sides of the respective crescent-shaped recess face each other and run parallel and spaced from each other forming said intermediate portion.

Said separate fastening portion 140 comprises fastening member 144 for fastening said fastening portion at the side 20a of the planet carrier 20. Said fastening member 144 may be constituted by any suitable fastening member such as a screw connection or bolt connection. Hence, since the fastening portion 140 can be fastened to the planet carrier 20 prior to the assembling of the pin, no stop is required in the opposite end of the pin during the assembling stage, so that a simplified pin can be used without the edge portion 39 illustrated in FIGS. 4a-d.

The above description of the preferred embodiments of the present invention has been provided for illustrative and descriptive purposes. It is not intended to be exhaustive or to limit the invention to the alternatives described. Obviously, many modifications and variations will be apparent to the skilled person. The embodiments were chosen and described to best explain the principles of the invention and its practical applications, thereby enabling a skilled person to understand the invention of various embodiments and with the various modifications suitable for the intended use.

1. A device at a planet wheel where a planet wheel is rotatably journaled at a pin arranged to be supported by a planet carrier for supporting said planet wheel, wherein said pin is non-rotatably arranged in said planet carrier by opposed blocking members of the pin arranged to cooperate by a blocking portion of said planet carrier, and wherein said blocking members comprises projecting portions projecting from said planet carrier for cooperation with a locking configuration arranged to axially retain said pin in said planet carrier.

2. The device of claim 1, wherein said locking configuration comprises a locking ring arranged in a groove of said blocking members.

3. The device of claim 2, wherein said groove is arranged internally of said blocking members.

4. The device of claim 2, wherein said groove is arranged in said projecting portions of said blocking members.

5. The device of claim 1, wherein said locking configuration is arranged to resiliently act in said groove.

6. The device of claim 1, wherein said locking configuration is arranged to removably retain said pin in said planet carrier.

7. The device of claim 1, wherein said blocking portion comprises opposed recesses for said blocking members together with an intermediate portion running between said recesses.

8. The device of claim 1, wherein said planet carrier comprises a separate disc-shaped ring member along which the blocking portions are distributed circumferentially about said ring member.

9. The device of claim 1, wherein said planet carrier comprises separate fastening portions having blocking portions, which fastening portions are distributed circumferentially about said planet carrier.

10. The device of claim 1, wherein said pin has an overall cylindrical configuration and at one of its ends has an axial recess arranged, by a diametrically running recess, to form said opposed blocking members and wherein the groove of said blocking members is arranged in said axial recess.
